(19) United States
(12) Patent Application Publication
(10) Pub. No.: US 2022/0252707 A1
(43) Pub. Date: Aug. 11, 2022

(54) SYSTEM AND TECHNIQUES FOR CONFIGURING A TWO-DIMENSIONAL SEMIREGULAR SPARSE ARRAY OF SONAR DETECTOR ELEMENTS

(71) Applicant: CODA OCTOPUS GROUP, INC., Orlando, FL (US)

(72) Inventors: Jason Martin, Salt Lake City, UT (US); Charlie Pearson, Ilkley (GB)

(21) Appl. No.: 17/171,102

(22) Filed: Feb. 9, 2021

(51) Int. Cl. G01S 7/521; G01S 15/89; G01S 7/526

(52) U.S. Cl. CPC G01S 7/521; G01S 7/526; G01S 15/89

(57) ABSTRACT

Technologies for configuring a two-dimensional (2D) semi-regular sparse array of sonar detector elements are disclosed. The 2D array may be formed from a non-uniform one-dimensional (1D) array of non-uniform arrays. The 2D array may be composed of two or more 1D arrays with non-uniform spacing patterns of sonar detector elements in a first direction arranged parallel relative to one another with a non-uniform spacing pattern between the 1D arrays forming a 1D array in a second direction. The output data from the array may be used as input for a beamforming technique.

### FIELD

Embodiments presented herein generally relate to sonar imaging, and more specifically, to configuring sonar detector elements of a sonar computing device as a two-dimensional (2D) semi-regular sparse array.

### BACKGROUND

A sonar generator may produce sonar imaging data by sending one or more sonar signal pulses into a volume of fluid, also known as insonifying the volume of fluid. Doing so causes objects within the insonified volume to reflect sound energy. One or more detector elements of a detector array may record the reflected sound energy. Generally, this process of transmitting sonar pulses, or pings, is repeated at a given frequency. Once the detector array receives reflected pings, each detector element may digitize and condition an analog electrical voltage signal to provide raw data indicative of the reflected sonar wave phase and magnitude for each detector. Thereafter, the detector array may transform the raw data into beamformed data, which provides points representative of the location in a three-dimensional (3D) space from where the signals were reflected.

Beamforming generally relates to techniques for generating, from the raw data, a 3D array of values (e.g., magnitude and phase) corresponding to measurements within an insonified volume for a given ping. This 3D array representing a cuboid view volume is also referred to herein as full time series data or beamformed data or data in “beam space.” Through further processing and optionally visualization, the cuboid view volume of full time series data may be transformed into “world space,” in which the data is represented in three dimensional polar space coordinates as a function of distance or range and of two orthogonal angles with respect to the position and orientation of detectors.

Generally, the configuration of the detector array influences the beamforming and consequently influences the resulting sonar imaging data. One consideration for the configuration is to avoid aliasing in the imaging data. To accomplish this, the detector array elements may be closely spaced, e.g., using half-wavelength spacing. Another consideration is that the imaging data should be relatively high-resolution, given constraints that a beamwidth along one direction is inversely proportional to a size of an array aperture in that dimension. To obtain a high-resolution image while avoiding aliasing, a fully populated array would require a large number of elements in both directions.

Sparse two-dimensional (2D) arrays can be used to mitigate compute cost and physical constraints of a large number of closely-spaced array elements to achieve high-resolution unaliased image data. In such configurations, some elements are closely spaced (e.g., to avoid aliasing) and others are more widely spaced (e.g., to obtain a large array aperture). However, current approaches for configuring sparse arrays for sonar images can adversely affect the performance of beamforming methods used on raw data as it prohibits the use of regularized beamforming methods such as Fast Fourier Transform beamforming or other two-pass beamforming techniques.

### SUMMARY

One embodiment presented herein discloses a sonar computing device. The sonar computing device generally includes a detector array subsystem comprising a plurality of elements configured to receive a signal representative of a reflected sonar ping. At least a portion of the elements of the detector array subsystem are spatially arranged as a two-dimensional (2D) sparse array formed from two or more one-dimensional (1D) arrays in a first direction arranged parallel relative to a longitudinal axis of one another arranged with a non-uniform spacing pattern of the 1D arrays in the first direction as a 1D array in a second direction. Respective elements of the plurality of elements in each of the 1D arrays in the first direction have a non-uniform spacing pattern. The sonar computing device also generally includes a data acquisition subsystem configured to process, from the detector array subsystem, raw data representing a three-dimensional 3D volumetric view of a space. The sonar computing device also generally includes a beamforming subsystem configured to beamform the processed raw data.

Another embodiment presented herein discloses a sonar detector array. The sonar detector array generally includes a housing and a transducer assembly operatively connected with the housing. The transducer assembly comprises a plurality of detector elements configured to generate a signal representative of a reflected sonar ping. At least a portion of the detector elements are spatially arranged as a 2D sparse array formed from two or more 1D arrays in a first direction arranged parallel relative to a longitudinal axis of one another arranged with a non-uniform spacing pattern of the 1D arrays in the first direction as a 1D array in a second direction, wherein respective elements of the plurality of elements in each of the 1D arrays in the first direction have a non-uniform spacing pattern.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified conceptual diagram of at least one embodiment of an example underwater environment in which sonar imaging data is processed;

FIG. 2 is a conceptual diagram of an example view volume representation of beamformed data;

FIG. 3 is a conceptual diagram of an example coordinate system for a three-dimensional world space;

FIG. 4 is a conceptual diagram of a volume of space of interest divided into a number of subsections corresponding to voxels of a view volume after transformation into world space;

FIG. 5 is a conceptual diagram of an example non-uniform array configuration for a detector element array in which logarithmic element spacing is deployed in each direction;

FIG. 6 is a conceptual diagram of an example configuration of non-uniform spacing for each direction of a detector array in which the spacing pattern of elements within one-dimensional arrays in a first direction and the spacing pattern between the 1D arrays in a second direction are identical;

FIG. 7 is a conceptual diagram of another example configuration of non-uniform spacing for each direction of a detector array in which the spacing pattern of elements within one-dimensional arrays in a first direction and the spacing pattern between the 1D arrays in a second direction differ;

FIG. 8 is a conceptual diagram of yet another example configuration of non-uniform spacing for each direction of a detector array in which the spacing pattern of elements within one-dimensional arrays in a first direction and the spacing pattern between 1D arrays in a second direction differ and also in which the spacing pattern between elements within one-dimensional arrays in the first direction differ between parallel one-dimensional arrays;

FIG. 9 is a simplified block diagram of a sonar computing device configured with a two-dimensional semi-regular sparse detector element array; and

FIG. 10 is a simplified flow diagram of a method for beamforming data captured using elements of a two-dimensional semi-regular sparse detector element array.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

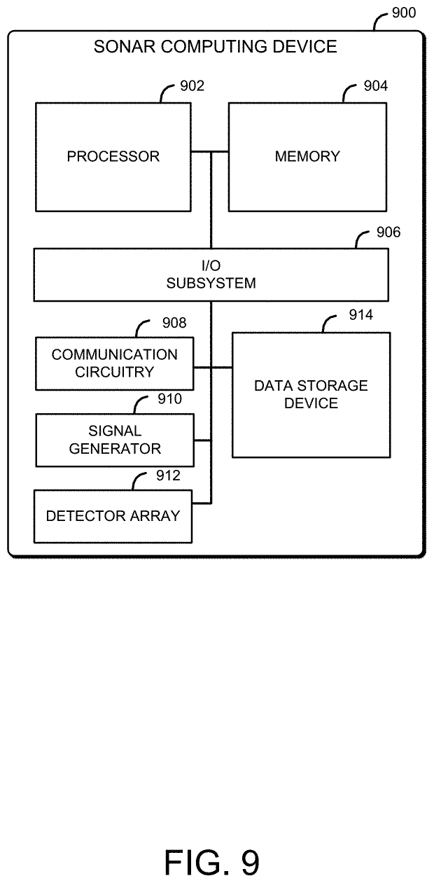

Generally, a sonar computing device may include a 2D multi-element detector array that obtains raw data underwater. An example sonar computing device 900 is described herein with regard to FIG. 9. The sonar computing device, for example, prior to transmitting the data to a vessel system (e.g., for visualization or storage), preprocesses the data using techniques such as beamforming. The configuration of detector array elements may influence the quality and resolution of the beamformed data, so it is desirable that if a sparse 2D array configuration is used, the configuration should be such that a high resolution and unaliased image data can be generated using a compatible beamforming technique.

To address these considerations, embodiments presented herein disclose techniques for configuring a sparse 2D semi-regular array of detector elements as a non-uniform one-dimensional (1D) array of a set of non-uniform 1D arrays. The 1D arrays in a set of 1D arrays in a first direction are parallel to one another, but may have different non-uniform element spacing patterns and may have different numbers of elements with respect to one another. This set of parallel 1D arrays in the first direction are then arranged such that the spacing between them is given by a non-uniform 1D array in a second direction orthogonal to the first direction. The spacing pattern of the elements of the resulting 2D array are non-uniform. The resulting 2D sparse array may be used as input for various beamforming techniques, such as a two-pass beamforming scheme.

Advantageously, the embodiments disclosed herein provide a semi-regular 2D array that facilitates design and manufacturing of sonar computing device equipment due to the techniques simplifying the determination of element positions. Further, simplifying the underlying channel electronics in the detector array required for beamforming, this approach potentially reduces cost, power, and space required for the device. Further still, the semi-regular configuration of the array allows for a variety of efficient beamforming techniques that typically are incompatible with the use of sparse 2D arrays.

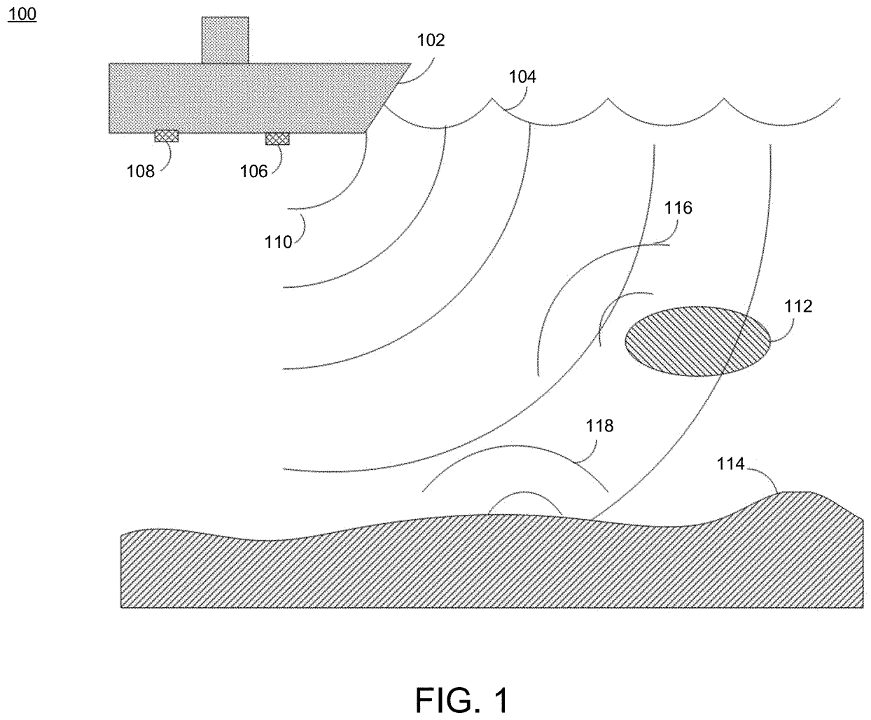

Referring now to FIG. 1, an example underwater environment 100 in which sonar imaging data is obtained and processed is shown. Illustratively, FIG. 1 depicts a sea vessel 102 atop an ocean 104. The sea vessel 102 may be embodied as any water vehicle capable of traveling a body of water, such as the ocean 104. The sea vessel 102 includes a number of sound navigation and ranging (SONAR) equipment, such as a sonar generator 106 and a detector 108. In an embodiment, the detector 108 may correspond to a multi-element detector array. Although depicted as separate components, the sonar generator 106 and detector 108 may be incorporated into a single sonar computing device. The sonar computing device may be adapted to a variety of settings, such as being attached to a cable or wire from the sea vessel 102, embodied within a robot, embodied within a remotely operated vehicle, and the like. Further, the sonar computing device (and individual components such as the sonar generator 106 and the detector 108) may include communication circuitry to send data collected and processed (e.g., segmentation data) to a remote device, such as a management console located within the sea vessel 102.

In an embodiment, the sonar generator 106 produces a sonar pulse. Illustratively, the sonar generator 106 insonifies a volume of fluid by transmitting a series of sound waves 110 at a given frequency in a relatively conical shape. The pulses of the sound waves 110 are generally short (e.g., within a range of 10 to 100 microseconds) and spread relatively broadly over an angular range. Using known sonar-based techniques, the sonar equipment of the sea vessel 102 may derive raw imaging data indicative of an underwater scene from signals reflected by objects in the sea and received by the detector 108. Objects within range of the sound waves 110, such as a suspended object 112, seabed 114, or objects buried under the seabed 114 may reflect the sound waves, shown as sound waves 116 and 118 for the suspended object 112 and the seabed 114, respectively. Sound waves may also be re-reflected from the water surface of the ocean 104. Generally, a reflected ping signal (e.g., corresponding to sound waves 116 or 118) may arrive at the detector 108 in approximately twice the time taken for a ping signal (e.g., corresponding to sound waves 110) to travel to an object in the insonified volume. A measurement of time continues until the reflected ping signal of a furthest object of interest reaches the detector 108. The total measurement time may be subdivided into time slices at fixed intervals, and the interval may be set to match a predetermined range resolution and a corresponding temporal resolution, tₛ. Once the detector 108 receives reflected ping signals, each detector element may digitize and condition an analog electrical voltage signal to provide raw data representing reflected sonar wave phase and magnitude in each time slice.

The sonar generator 106 may use a master oscillator square wave to provide pulses at a frequency 4f timed to edges of the master oscillator square wave. As a result, each element in the detector 108 may sample a received signal at phases 0, 90, 180, and 270 degrees of the master oscillator square wave. Sampling at 0 and 180 degrees provides real parts, and sampling at 90 and 270 degrees provides the imaginary parts of the reflected sound wave with respect to the master oscillator square wave. The sum of the squares of the real and imaginary parts provide the magnitude of the sound wave at each individual detector, and the ratio of the real and imaginary parts is the tangent of the phase angle. The detector 108 may sample the sound wave pressure with 12- or 16-bit accuracy. The reflected ping signals may be subdivided into a series of time slices having a temporal resolution, tₛ, and a range resolution, lₛ. While different values for a slice spacing, pulse length, and sonar wavelength may be used, in practice, a slice spacing of 3 cm, a pulse length of 7 cm, and a sonar wavelength of 4 mm may produce desired results. Each time slice is numbered from t₁ to tₙ. Thus, for each time slice, the detector 108 may apply a quadrature filter and digitize the signal. Doing so generates a pair of 12- or 16-bit real and imaginary numbers which give the phase and magnitude of the reflected wave measured by each detector for that time slice.

The detector 108 may use beamforming techniques on the digitized data to provide points in a three-dimensional (3D) space. The beamforming techniques may return beamformed data representing a view volume. More particularly, the beamformed data, also referred to herein as full time series data, is a 3D array of values (e.g., phase, magnitude, etc.) corresponding to measurements from points contained within a given insonified volume for a given ping. Each value is associated with a given voxel in the 3D space. The 3D array may represent a roughly conical volume in world space. In some cases, the voxel data may represent mosaicked multi-ping 3D sonar data of an insonified volume, in which a voxel includes at least the number of mosaicked 3D data sets including a signal at a given region of an insonified volume.

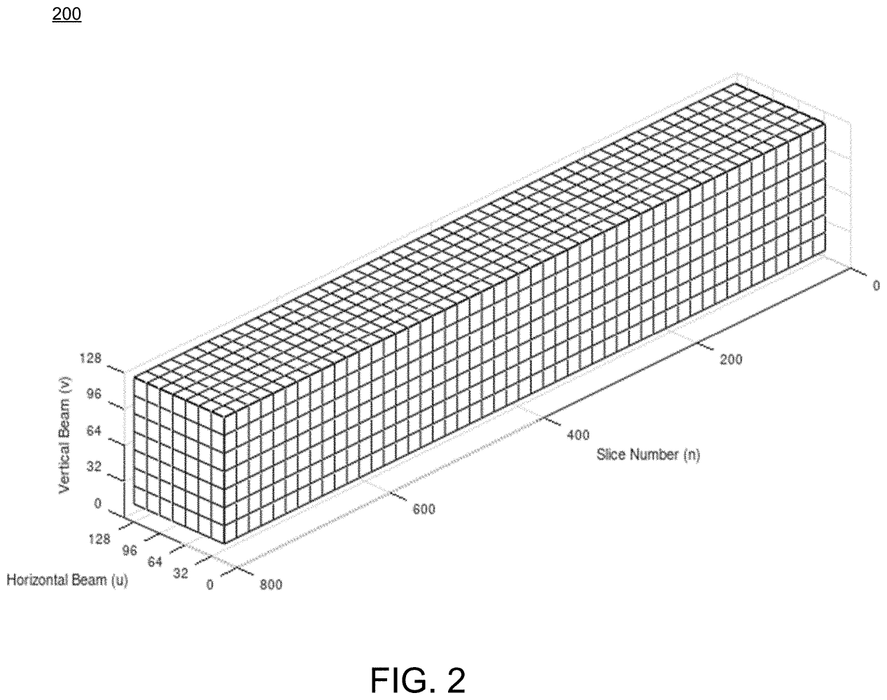

In an embodiment, the view volume may be represented as a cuboid. FIG. 2 shows an example of a cuboid 200 representing a view volume. Generally, the cuboid 200 represents a space facing the detector 108 within a given field of view that extends along an horizontal direction from a minimum value to a maximum value; along the vertical direction from a minimum value of to a maximum value of; and along the range direction from a minimum range to a maximum range. Illustratively, the view volume is quantized in U, V and range to discrete values, splitting or segmenting the volume into a regularly spaced 3D grid of voxels, each voxel including at least one measured value (e.g., phase, magnitude, etc.) and positional information for the measured value. The voxels with the same value of range are at the same distance, which may be referred to as a “slice.” The U and V values correspond to beam angles. Each voxel may be identified by its coordinates in U, V and range and a phase and a magnitude value.

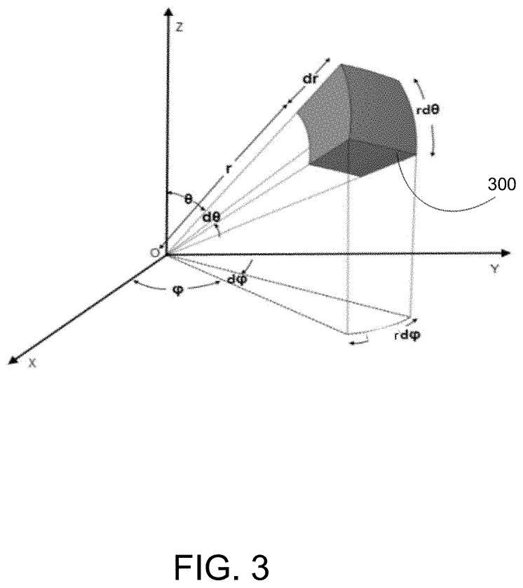

Further, in an embodiment, the sonar computing device may transform the view volume depicted in cuboid 200 into world space, in which data is represented in 3D space polar coordinates as a function of range and of two orthogonal angles relative to the plane of the detector 108. Doing so allows the sonar computing device to perform further processing and visualization with the data. Referring now to FIG. 3, a coordinate system in which one subsection of length δ r having lateral dimensions rδθ and rδϕ his shown. As shown, the central point of the subsection 300 is located at range r and two orthogonal angular coordinates θ and ϕ. In world space, volume and component subsections corresponding to voxels in volume space may be represented by 3D pyramidal frusta including truncated pyramidal sections of a sphere between two radii.

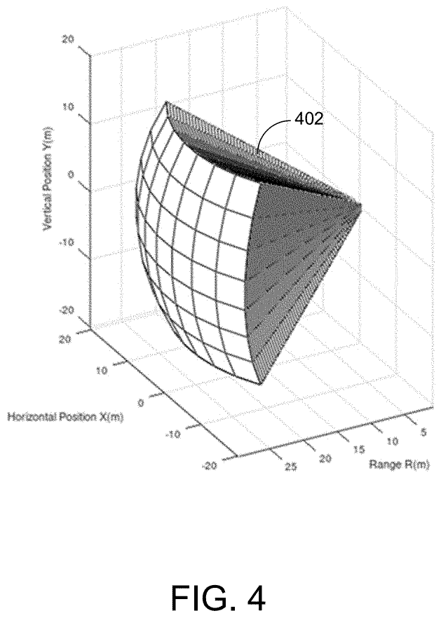

Referring briefly to FIG. 4, as shown, a volume 402 of space of interest may be divided into a large number of subsections corresponding to voxels of the full time series data. A beam corresponds to a set of touching subsections, wherein θ, ϕ, δθ and δϕ are fixed, and r runs from rₘᵢₙ to rₘₐₓ, A beam represented by a set S _{rθ ϕ} has length Nδr, where N δr is the distance between rₘᵢₙ and rₘₐₓ, with voxels of the same length δr and increasing values rδθ and rδϕ. Thus, the area of the beam is continually increasing further from the origin.

As the resulting beamform is influenced by the configuration of elements in the detector 108, spacing and positioning of array elements of the detector 108 should be arranged to produce optimized input to the beamformer. In an embodiment, a 2D array that is formed of a non-uniform 1D array of a set of non-uniform 1D arrays may be used. The 1D arrays of a set of 1D arrays in a first direction are parallel to one another, but may have different non-uniform element spacing patterns and may have different numbers of elements with respect to one another. This set of parallel 1D arrays in the first direction is then arranged such that the spacing pattern between the parallel 1D arrays in the set is given by a non-uniform 1D array in a second direction orthogonal to the first direction. There may be lateral offsets between each of the 1D arrays, such that the centers of each of the 1D arrays may lie on an arbitrary line or curve that is not orthogonal to the first direction. This means that the overall shape of the 2D array is not necessarily rectangular or any other regular shape.

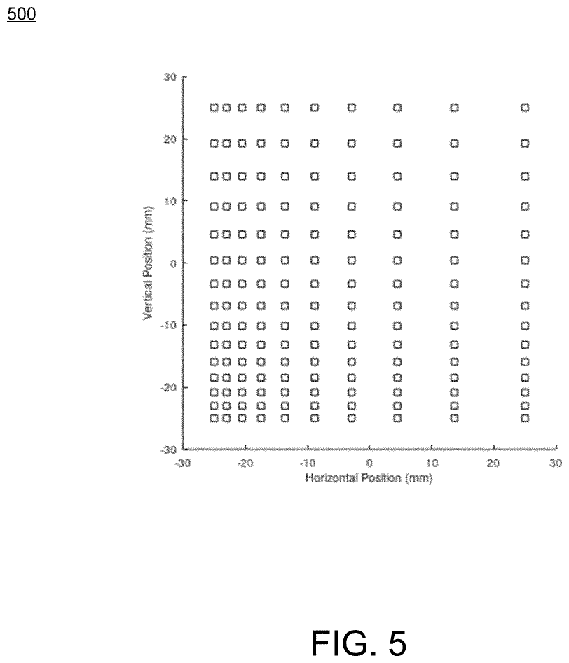

As further described herein, the spacing pattern of elements within the 1D arrays of the set of parallel 1D arrays in the first direction and the spacing pattern between the parallel 1D arrays in the second direction need not be the same. In an embodiment, a logarithmic element spacing may be used for both spacing patterns. FIG. 5 depicts a positioning of array elements of the detector 108 using a logarithmic spacing of the elements, in which the x-axis represents positions along a horizontal direction and the y-axis represents positions along a vertical direction. Illustratively, the number of elements is different in the two directions. Consequently, the spacing pattern between each pair of elements is unique, which equates to sampling an incoming sound wave at a large number of spacings that are not multiples of one another, which assists in avoiding aliasing of resulting sonar imaging data. Compared to other array configuration techniques, doing so results in relatively better frequency discrimination because a considerable amount of sampled spacings are distinct to one another.

Using the above techniques, various configurations of non-uniform spacing patterns may be applied. For example, certain configurations, when applied, may achieve a given array beam pattern. In the following examples, assume that a 1D vector has N non-uniform element output coordinates Rᵢ(i=1 . . . N), in which the array aperture is the distance between the two most widely spaced elements in the vector. These various configurations may be defined by 2D coordinates formed by combining various non-uniform 1D coordinate vectors.

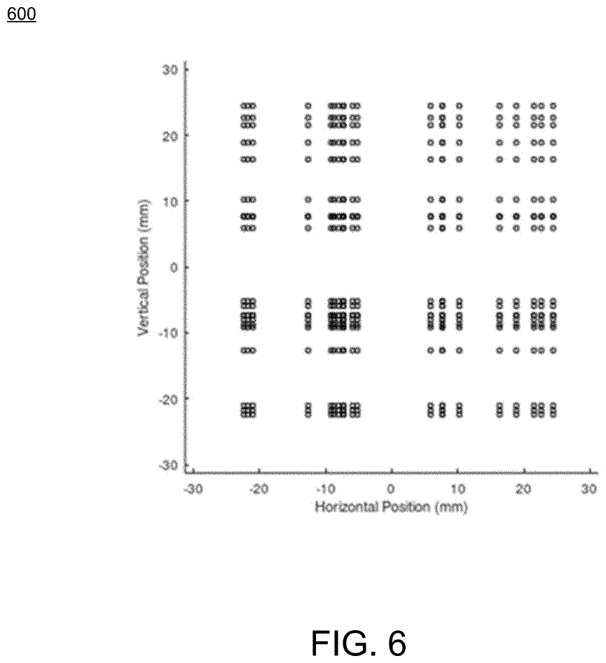

Referring now to FIG. 6, an example array configuration 600 in which the spacing pattern of the elements within the set of parallel 1D arrays in a first direction and the spacing pattern between the parallel 1D arrays in a second direction of the 2D detector array are the same non-uniform spacing pattern is shown. In this example, element coordinates in the first direction (the x-axis direction on FIG. 6) and the second direction (the y-axis direction on FIG. 6) are defined using a single non-uniform coordinate vector, R₀, which results in a 2D array of element coordinates representable as:

$$Array Elements [ x , y ] = [ \begin{matrix}[ {R}_{0 , 1} , {R}_{0 , 1} ] & … & [ {R}_{0 , 1} , {R}_{0 , N} ] \\ ⋮ & ⋱ & ⋮ \\ [ {R}_{0 , N} , {R}_{0 , 1} ] & … & [ {R}_{0 , N} , {R}_{0 , N} ]\end{matrix} ]$$

This configuration allows beamforming coefficients to be identical in the first direction and the second direction. Advantageously, using identical coefficients reduces memory requirements in the sonar computing device when beamforming.

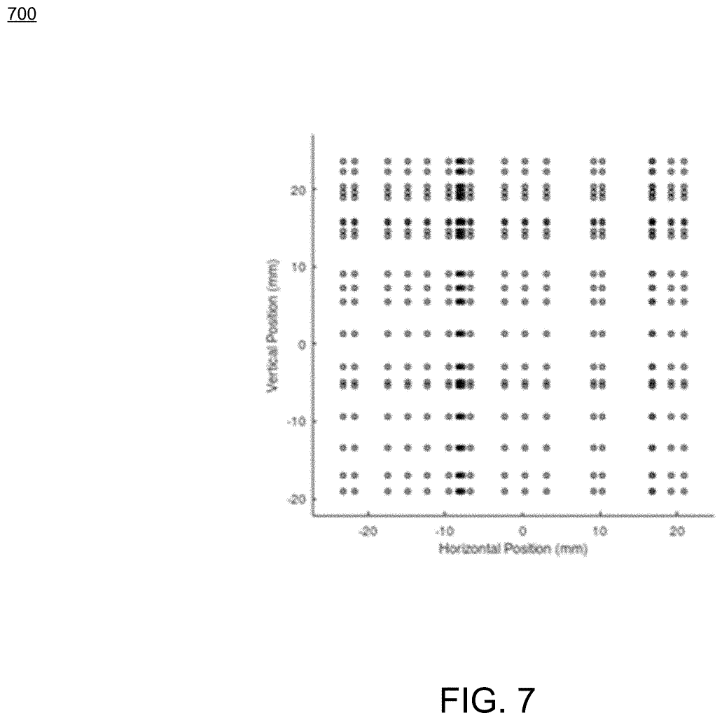

Referring now to FIG. 7, another example configuration 700 in which the spacing pattern of elements within the set of parallel 1D arrays in a first direction and the spacing pattern between the parallel 1D arrays in a second direction differ is shown. In this example, the element coordinates in the first and second direction are defined using non-uniform coordinate vectors R_{X} for rows and R_{Y} for columns. The 2D array formed from the combination of the vectors yields:

$$Array Elements [ x , y ] = [ \begin{matrix}[ {R}_{X , 1} , {R}_{Y , 1} ] & … & [ {R}_{X , 1} , {R}_{Y , N} ] \\ ⋮ & ⋱ & ⋮ \\ [ {R}_{X , N} , {R}_{Y , 1} ] & … & [ {R}_{X , N} , {R}_{Y , N} ]\end{matrix} ]$$

By spacing the elements within the set of parallel 1D arrays differently from the spacing between the parallel 1D arrays, imaging data may be optimized along a given direction. For example, objects being observed by the sonar computing device, such as a harbor, may require more resolution in one direction over the other.

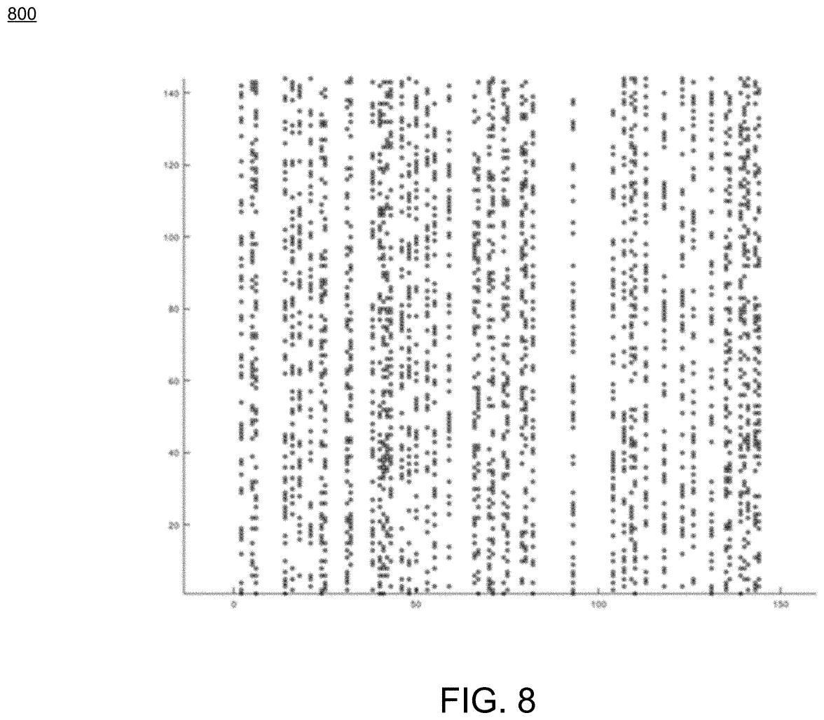

Referring now to FIG. 8, yet another example configuration 800 in which the non-uniform spacing pattern of elements within the set of parallel 1D arrays in one direction and the non-uniform spacing pattern between the parallel 1D arrays in a second direction differ from one another, and the non-uniform spacing pattern between the elements of each of the 1D arrays in the set of parallel 1D arrays in the first direction are also different between parallel 1D arrays. In this example, element coordinates in a first direction coordinate vector R_{X} are given. Further, each 1D array in the first direction is defined by a separate 1D non-uniform coordinate vector R_{Yi} for each column i. The 2D array of elements formed from the combination of vectors is represented as:

$$Array Elements [ x , y ] = [ \begin{matrix}[ {R}_{X , 1} , {R}_{Y 1 , 1} ] & … & [ {R}_{X , 1} , {R}_{Y N , N} ] \\ ⋮ & ⋱ & ⋮ \\ [ {R}_{X , N} , {R}_{Y 1 , 1} ] & … & [ {R}_{X , N} , {R}_{Y N , N} ]\end{matrix} ]$$

The misalignment in the horizontal direction depicted in FIG. 8 can improve imaging performance by reducing sidelobes. That is, the sidelobes from each column will not match, which mitigates any influence that the sidelobes can have on the resulting beam patterns.

Referring now to FIG. 9, a sonar computing device 900 may be embodied as any type of device capable of performing the functions described herein. As shown, the illustrative sonar computing device 900 includes a processor 902, a memory 904, an input/output (I/O) subsystem 906, communication circuitry 908, a data storage device 914, a signal generator 910, and a detector array 912. Of course, in other embodiments, the sonar computing device 900 may include other or additional components, such as those commonly found in a computer (e.g., display, peripheral devices, etc.) or as part of sonar equipment. Additionally, in some embodiments, one or more of the illustrative components may be incorporated in, or otherwise form a portion of, another component. For example, the detector array 912 may be incorporated in a detector array subsystem. As another example, various components such as a the processor 902, the memory 904, and signal generator 910 may form a data acquisition subsystem configured to process raw data from the detector array subsystem. As yet another example, various components such as the processor 902 and the memory 904 may form a beamforming subsystem configured to beamform processed raw data.

The processor 902 may be embodied as one or more processors, each processor being a type capable of performing the functions described herein. For example, the processor 902 may be embodied as a single or multi-core processor(s), a microcontroller, or other processor or processing/controlling circuit. In some embodiments, the processor 902 may be embodied as, include, or be coupled to a field programmable gate array (FPGA), an application-specific integrated circuit (ASIC), reconfigurable hardware or hardware circuitry, or other specialized hardware to facilitate performance of the functions described herein.

The memory 904 may be embodied as any type of volatile (e.g., dynamic random access memory, etc.) or non-volatile memory (e.g., byte addressable memory) or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces.

In one embodiment, the memory device is a block addressable memory device, such as those based on NAND or NOR technologies. In one embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the die itself and/or to a packaged memory product. In some embodiments, all or a portion of the memory 904 may be integrated into the processor 902.

The processor 902 and the memory 904 are communicatively coupled with other components of the sonar computing device 900 via the I/O subsystem 906, which may be embodied as circuitry and/or components to facilitate input/output operations with the processor 902 and/or the memory 904 and other components of the sonar computing device 900. For example, the I/O subsystem 906 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 906 may form a portion of a system-on-a-chip (SoC) and be incorporated, along with one or more of the processor 902, the memory 904, and other components of the sonar computing device 900.

The communication circuitry 908 may be embodied as any communication circuit, device, or collection thereof, capable of enabling communications over a network between the sonar computing device 900 and other devices (e.g., a management console on the sea vessel 102). The communication circuitry 908 may be configured to use any one or more communication technology (e.g., wired, wireless, and/or cellular communications) and associated protocols (e.g., Ethernet, Bluetooth®, Wi-Fi®, WiMAX, 5G-based protocols, etc.) to effect such communication. For example, to do so, the communication circuitry 908 may include a network interface controller (NIC, not shown), embodied as one or more add-in-boards, daughtercards, controller chips, chipsets, or other devices that may be used by the sonar computing device 900 for network communications with remote devices. For example, the NIC may be embodied as an expansion card coupled to the I/O subsystem 906 over an expansion bus such as PCI Express.

The illustrative data storage device 914 may be embodied as any type of devices configured for short-term or long-term storage of data such as, for example, memory devices and circuits, memory cards, hard disk drives (HDDs), solid-state drives (SSDs), or other data storage devices. The data storage device 914 may include a system partition that stores data and firmware code for the data storage device 914. The data storage device 914 may also include an operating system partition that stores data files and executables for an operating system.

The signal generator 910 may be embodied as any type of device or circuitry capable of generating sonar pulse signals and transmitting the sonar pulse signals in a physical space. The detector array 912 may be embodied as any type of device or circuitry capable of receiving signals reflected by objects in response to contact with the generated sonar pulse signals. The detector array 912 may include a housing and a transducer assembly connected with the housing. The transducer assembly may include channel electronics having a two-dimensional array of detector elements (e.g., hydrophones). The channel electronics comprise signal processing channels that each incorporate a combination of outputs from the detector elements. Although depicted as separate components, the signal generator 910 and detector array 912 may be incorporated into a sonar equipment device housed within the sonar computing device 900.

The sonar computing device 900 may establish an environment during operation in which the functions described herein are performed. The environment includes logic that may be carried out by one or more components of the sonar computing device 900 by execution of the processor 902, such as the signal generator 910, detector array 912, and memory 904.

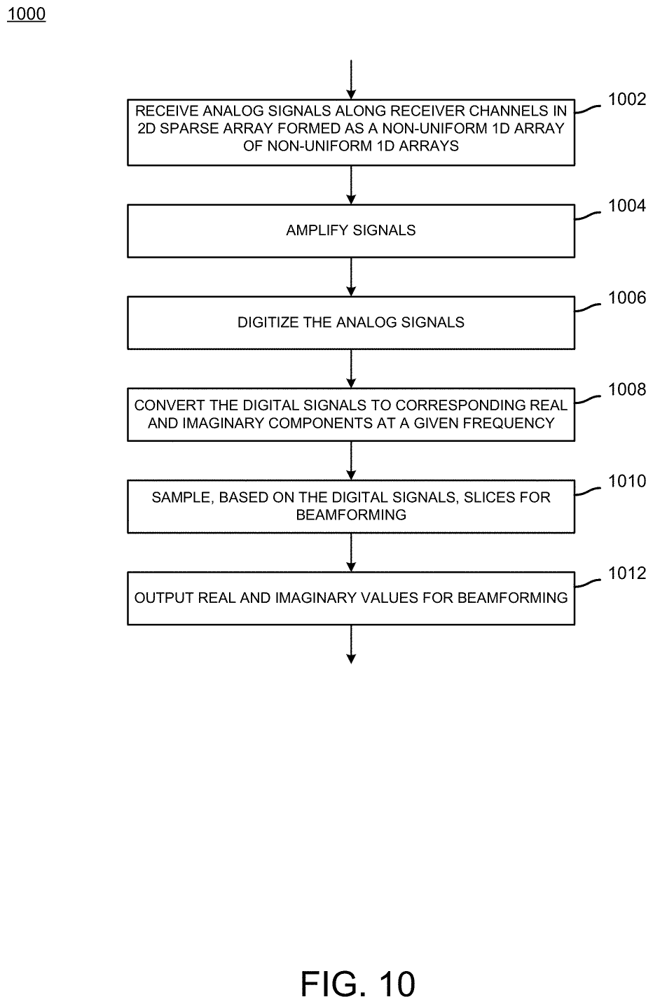

Referring now to FIG. 10, the sonar computing device 900, in operation, performs a method 1000 for processing signal data received at each receiver channel by the detector 108 in a 2D non-uniform, semi-regular sparse array configuration. As shown, the method 1000 begins in block 1002, in which the receiver channels of the detector 108 receives analog signals. The receiver channels are configured in a non-uniform 2D sparse array according to the techniques described herein. For example, the 2D sparse array may be in a logarithmic element spacing pattern having a different number of elements in each direction. The 2D sparse array may be further spaced in a variety of configurations. For instance, the 2D sparse array may be configured as a set of parallel 1D arrays of detector elements in a first direction, where the set of parallel 1D arrays is arranged such that the spacing patter between the parallel 1D arrays in the set of parallel 1D arrays is given by a non-uniform 1D array in a second direction. The spacing pattern of the detector elements in each 1D array of the set of parallel 1D arrays may be configured to have the same non-uniform element spacing pattern as the non-uniform spacing pattern of the 1D array in the second direction. Another configuration that may be adapted is by having the non-uniform spacing pattern of the detector elements in each of the 1D array of the set of parallel 1D arrays in the first direction be the same across the set of parallel 1D arrays but differ from the non-uniform spacing pattern of the 1D array in the second direction. Yet another configuration has the non-uniform spacing pattern of the detector elements in each of the 1D array of the set of parallel 1D arrays in the first direction differ across the set of parallel 1D arrays as well as differ from the non-uniform spacing pattern of the 1D array in the second direction.

In block 1004, the sonar computing device 900 may amplify the signals. The sonar computing device 900 may carry out the amplification using a charge amplifier and voltage-controlled amplifier components within the device 900. In block 1006, the sonar computing device 900 digitizes the signals using analog-to-digital signal converter components within the device 900. In block 1008, the sonar computing device 900 converts, via a quadrature filter within the device 900, the digital signals from real and time-domain signals to real and imaginary components at a given frequency.

In block 1010, the sonar computing device 900 samples slices from the converted real and imaginary components. The slices may be used for beamforming. In block 1012, the channel electronics of the detector 108 may thereafter output the slices, the real values, and the imaginary values, to the beamformer. Based on the type of configuration used for the 2D sparse array, the underlying process for beamforming can vary. For example, assume that a two-pass beamformer is used. Of course, other beamformers may be used, such as a two-pass delay-and-sum beamformer to accommodate broadband beamforming.

In the event that the 2D array is configured as a 1D vertical array of 1D horizontal arrays of detector elements, beamforming can occur at two passes. In the first pass, a vector of expected coefficients for M vertical beams is multiplied with a matrix of complex channel data. The beamformer multiplies an output vector of the first pass by a vector of expected coefficients for N horizontal beams, which results in a matrix of N×M output beams. If the spacing pattern of each of the 1D array elements of the set of parallel 1D arrays is identical to the spacing pattern of the 1D array of parallel 1D arrays, the beamformer can multiply every horizontal or vertical array by identical beamforming coefficients for a given beam angle. In the event that vertical 1D array of 1D horizontal arrays of detector elements use different non-uniform spacing patterns for the spacing of horizontal and vertical detector elements, each channel output of the 2D sparse array will use a separate coefficient in the first pass due to each channel being differently spaced in the second direction.

In an embodiment, the sonar computing device 900 may also generate the non-uniform and semi-regular 2D sparse array by sampling a set of data channels from a fully-populated and regular grid of array elements such that the sampled channels form a non-uniform 1D array of parallel non-uniform 1D arrays. To do so, the sonar computing device 900 may include physical switches that, according to a predefined configuration, select data channels to be read for beamforming. Alternatively, the system may read in all data channels and select the channels for beamforming by applying a weighting function, whereby some elements from the regular array are given a weighting of zero so that they are not included in the beamforming process.

In another embodiment, the sonar computing device 900 may also generate the non-uniform and semi-regular 2D sparse array by combining multiple element outputs along signal processing channels along at least one direction. Doing so effectively creates a non-uniform 1D array of non-uniform 1D arrays. The sonar computing device 900 may combine multiple elements in the 2D array at different points in the resulting receiver chain prior to beamforming. Such an approach advantageously increases the overall sensitivity of the sonar computing device 900.

In an embodiment, the sonar computing device 900 may optimize non-uniform, semi-regular sparse array patterns (e.g., such as in the configurations described herein) according to frequency using techniques such as simulated annealing or complex optimization. In such a case, the sonar computing device 900 may sample such array patterns from a fully-populated and regular-grid of 2D array elements. The resulting beamforming output may be optimized for a wide range of sonar transmit frequencies.

### EXAMPLES

Illustrative examples of the technologies disclosed herein are provided below. An embodiment of the technologies may include any one or more, and any combination of, the examples described below.

Example 1 includes a sonar computing device comprising a detector array subsystem comprising a plurality of elements configured to receive a signal representative of a reflected sonar ping, wherein at least a portion of the elements of the detector array subsystem are spatially arranged as a two-dimensional (2D) sparse array formed from two or more one-dimensional (1D) arrays in a first direction arranged parallel relative to a longitudinal axis of one another arranged with a non-uniform spacing pattern of the 1D arrays in the first direction as a 1D array in a second direction, wherein respective elements of the plurality of elements in each of the 1D arrays in the first direction have a non-uniform spacing pattern; and a data acquisition subsystem configured to process, from the detector array subsystem, raw data representing a three-dimensional (3D) volumetric view of a space; and a beamforming subsystem configured to beamform the processed raw data.

Example 2 includes the subject matter of Example 1, and wherein the first direction and the second direction are orthogonal relative to one another.

Example 3 includes the subject matter of any of Examples 1 and 2, and further including a plurality of signal processing channels, the signal processing channels each incorporating at least one of the plurality of detector elements, and wherein the 2D sparse array is generated as a function of a combination of multiple outputs from the signal processing channels in at least one direction.

Example 4 includes the subject matter of any of Examples 1-3, and wherein the respective elements in at least one of the 1D arrays in the first direction are spaced logarithmically relative to one another.

Example 5 includes the subject matter of any of Examples 1-4, and wherein the 1D arrays in the first direction are spaced logarithmically relative to one another in the second direction.

Example 6 includes the subject matter of any of Examples 1-5, and wherein the non-uniform spacing pattern of at least two of the 1D arrays in the first direction are identical.

Example 7 includes the subject matter of any of Examples 1-6, and wherein the spacing pattern in the second direction of the 1D arrays in the first direction has a non-uniform spacing pattern identical to the non-uniform spacing pattern of the elements of the plurality of elements in each of the 1D arrays in the first direction.

Example 8 includes the subject matter of any of Examples 1-7, and wherein the spacing pattern in the second direction of the 1D arrays in the first direction has a non-uniform spacing pattern that differs from the non-uniform spacing pattern of the elements of the plurality of elements in each of the 1D arrays in the first direction.

Example 9 includes the subject matter of any of Examples 1-8, and wherein the 2D sparse array is further formed as a function of a sampling a set of data channels from a fully-populated and regular array grid of the plurality of elements.

Example 10 includes the subject matter of any of Examples 1-9, and wherein the 2D sparse array comprises a plurality of physical switches to sample the set of data channels.

Example 11 includes the subject matter of any of Examples 1-10, and wherein the 2D sparse array is further formed as a function of weighting channels, wherein one or more channels are predefined as unwanted channels, and wherein the unwanted channels are assigned a weighting value of zero.

Example 12 includes the subject matter of any of Examples 1-11, and wherein to beamform the processed raw data is to beamform the processed raw data using two-pass beamforming.

Example 13 includes the subject matter of any of Examples 1-12, and wherein the 2D sparse array is generated based on a given sonar transmit frequency.

Example 14 includes a sonar detector array comprising a housing; a transducer assembly operatively connected with the housing, wherein the transducer assembly comprises a plurality of detector elements configured to generate a signal representative of a reflected sonar ping; and wherein at least a portion of the detector elements are spatially arranged as a two-dimensional (2D) sparse array formed from two or more one-dimensional (1D) arrays in a first direction arranged parallel relative to a longitudinal axis of one another arranged with a non-uniform spacing pattern of the 1D arrays in the first direction as a 1D array in a second direction, wherein respective elements of the plurality of elements in each of the 1D arrays in the first direction have a non-uniform spacing pattern.

Example 15 includes the subject matter of Example 14, and wherein the first direction and the second direction are orthogonal relative to one another.

Example 16 includes the subject matter of any of Examples 14 and 15, and wherein the respective elements in at least one of the 1D arrays in the first direction are spaced logarithmically relative to one another.

Example 17 includes the subject matter of any of Examples 14-16, and wherein the 1D arrays in the first direction are spaced logarithmically relative to one another in the second direction.

Example 18 includes the subject matter of any of Examples 14-17, and wherein the non-uniform spacing pattern of at least two of the 1D arrays in the first direction are identical.

Example 19 includes the subject matter of any of Examples 14-18, and wherein the spacing pattern in the second direction of the 1D arrays in the first direction has a non-uniform spacing pattern identical to the non-uniform spacing pattern of the elements of the plurality of elements in each of the 1D arrays in the first direction.

Example 20 includes the subject matter of any of Examples 14-19, and wherein the spacing pattern in the second direction of the 1D arrays in the first direction has a non-uniform spacing pattern that differs from the non-uniform spacing pattern of the elements of the plurality of elements in each of the 1D arrays in the first direction.

1. A sonar computing device comprising:
a detector array subsystem comprising a plurality of elements configured to receive a signal representative of a reflected sonar ping, wherein at least a portion of the elements of the detector array subsystem are spatially arranged as a two-dimensional (2D) sparse array formed from two or more one-dimensional (1D) arrays in a first direction arranged parallel relative to a longitudinal axis of one another arranged with a non-uniform spacing pattern of the 1D arrays in the first direction as a 1D array in a second direction, wherein respective elements of the plurality of elements in each of the 1D arrays in the first direction have a non-uniform spacing pattern;
a data acquisition subsystem configured to process, from the detector array subsystem, raw data representing a three-dimensional (3D) volumetric view of a space; and
a beamforming subsystem configured to beamform the processed raw data.

2. The sonar computing device of claim 1, wherein the first direction and the second direction are orthogonal relative to one another.

3. The sonar computing device of claim 1, further comprising a plurality of signal processing channels, the signal processing channels each incorporating at least one of the plurality of detector elements, and wherein the 2D sparse array is generated as a function of a combination of multiple outputs from at least one of the signal processing channels in at least one direction.

4. The sonar computing device of claim 1, wherein the respective elements in at least one of the 1D arrays in the first direction are spaced logarithmically relative to one another.

5. The sonar computing device of claim 1, wherein the 1D arrays in the first direction are spaced logarithmically relative to one another in the second direction.

6. The sonar computing device of claim 1, wherein the non-uniform spacing pattern of at least two of the 1D arrays in the first direction are identical.

7. The sonar computing device of claim 1, wherein the spacing pattern in the second direction of the 1D arrays in the first direction has a non-uniform spacing pattern identical to the non-uniform spacing pattern of the elements of the plurality of elements in each of the 1D arrays in the first direction.

8. The sonar computing device of claim 1, wherein the spacing pattern in the second direction of the 1D arrays in the first direction has a non-uniform spacing pattern that differs from the non-uniform spacing pattern of the elements of the plurality of elements in each of the 1D arrays in the first direction.

9. The sonar computing device of claim 1, wherein the 2D sparse array is further formed as a function of a sampling a set of data channels from a fully-populated and regular array grid of the plurality of elements.

10. The sonar computing device of claim 9, wherein the 2D sparse array comprises a plurality of physical switches to sample the set of data channels.

11. The sonar computing device of claim 9, wherein the 2D sparse array is further formed as a function of weighting channels, wherein one or more channels are predefined as unwanted channels, and wherein the unwanted channels are assigned a weighting value of zero.

12. The sonar computing device of claim 1, wherein to beamform the processed raw data is to beamform the processed raw data using two-pass beamforming.

13. The sonar computing device of claim 1, wherein the 2D sparse array is generated based on a given sonar transmit frequency.

14. A sonar detector array comprising:
a housing;
a transducer assembly operatively connected with the housing, wherein the transducer assembly comprises a plurality of detector elements configured to generate a signal representative of a reflected sonar ping; and
wherein at least a portion of the detector elements are spatially arranged as a two-dimensional (2D) sparse array formed from two or more one-dimensional (1D) arrays in a first direction arranged parallel relative to a longitudinal axis of one another arranged with a non-uniform spacing pattern of the 1D arrays in the first direction as a 1D array in a second direction, wherein respective elements of the plurality of elements in each of the 1D arrays in the first direction have a non-uniform spacing pattern.

15. The sonar detector array of claim 14, wherein the first direction and the second direction are orthogonal relative to one another.

16. The sonar detector array of claim 14, wherein the respective elements in at least one of the 1D arrays in the first direction are spaced logarithmically relative to one another.

17. The sonar detector array of claim 14, wherein the 1D arrays in the first direction are spaced logarithmically relative to one another in the second direction.

18. The sonar detector array of claim 14, wherein the non-uniform spacing pattern of at least two of the 1D arrays in the first direction are identical.

19. The sonar detector array of claim 14, wherein the spacing pattern in the second direction of the 1D arrays in the first direction has a non-uniform spacing pattern identical to the non-uniform spacing pattern of the elements of the plurality of elements in each of the 1D arrays in the first direction.

20. The sonar detector array of claim 14, wherein the spacing pattern in the second direction of the 1D arrays in the first direction has a non-uniform spacing pattern that differs from the non-uniform spacing pattern of the elements of the plurality of elements in each of the 1D arrays in the first direction.
